(19) United States
(12) Patent Application Publication
(10) Pub. No.: US 2013/0242189 A1
(43) Pub. Date: Sep. 19, 2013

(54) METHOD AND SYSTEM FOR PROVIDING SYNCHRONIZED PLAYBACK OF MEDIA STREAMS AND CORRESPONDING CLOSED CAPTIONS

(71) Applicants: Narendra B. Babu, Tamil Nadu (IN); Syed Mohasin Zaki, Tamil Nadu (IN); Venkata S. Adimatyam, Temple Terrace, FL (US); Jacques Franklin, Tamil Nadu (IN)

(72) Inventors: Narendra B. Babu, Tamil Nadu (IN); Syed Mohasin Zaki, Tamil Nadu (IN); Venkata S. Adimatyam, Temple Terrace, FL (US); Jacques Franklin, Tamil Nadu (IN)

(73) Assignee: Verizon Patent and Licensing Inc., Basking Ridge, NJ (US)

(21) Appl. No.: 13/418,872

(22) Filed: Mar. 13, 2012

(51) Int. Cl. H04N 7/00

(52) U.S. Cl. 348/468; 348/E07.033

(57) ABSTRACT

An approach for providing synchronized playback of media streams and corresponding closed captions is described. One or more portions of a media stream and corresponding closed caption data is received, at a virtual video server resident on a user device, from an external video server. The one or more portions of the media stream and the corresponding closed caption data is buffered by the virtual video server. The one or more portions of the media stream is delivered to a video player application and the corresponding closed caption data is delivered to a rendering application as to synchronize playback of the one or more portions of the media stream and the corresponding closed caption data by the respective applications, wherein the video player application and the rendering application are resident on the user device.

### BACKGROUND INFORMATION

Service providers are continually challenged to deliver value and convenience to consumers by providing compelling network services and advancing the underlying technologies. One area of interest has been the development of services and technologies relating to presentation of media content with closed captions. Traditionally, for instance, closed captions are part of the video stream, and a video player capable of rendering the closed captions will overlay the closed captions over the rendering of the video stream. In recent years, some video players may also draw closed captions for a video stream by rendering the associated text from a separate input file. Nonetheless, the video player may not always have the capability to render the closed captions over the video stream. In such a case where the video player cannot perform the required rendering function, the closed captions must be added over the video stream without support from the video player. Although a separate application may provide the rendering function for the closed captions, the individual renderings of the video stream and the closed captions may result in the video stream and the closed captions becoming out of synchronization with each other, which may, for instance, cause inaccurate or imprecise closed captions.

Therefore, there is a need for an effective approach for providing synchronized playback of media streams and corresponding closed captions.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing synchronized playback of media streams and corresponding closed captions, according to an exemplary embodiment;

FIG. 2 is a diagram of the components of a virtual video platform, according to an exemplary embodiment;

FIG. 3 is a diagram of interactions between components of an external video server and a user device, according to an exemplary embodiment;

FIG. 4 is a flowchart of a process for providing synchronized playback of media streams and corresponding closed captions, according to an exemplary embodiment;

FIG. 5 is a flowchart of a process for addressing synchronization issues with respect to playback of media streams and corresponding closed captions, according to an exemplary embodiment;

FIG. 6 is a diagram of a user interface for illustrating synchronization of a media stream and corresponding closed captions, according to an exemplary embodiment;

FIG. 7 is a diagram of a computer system that can be used to implement various exemplary embodiments; and

FIG. 8 is a diagram of a chip set that can be used to implement an embodiment of the invention.

### DESCRIPTION OF THE PREFERRED EMBODIMENT

An apparatus, method, and system for providing synchronized playback of media streams and corresponding closed captions are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

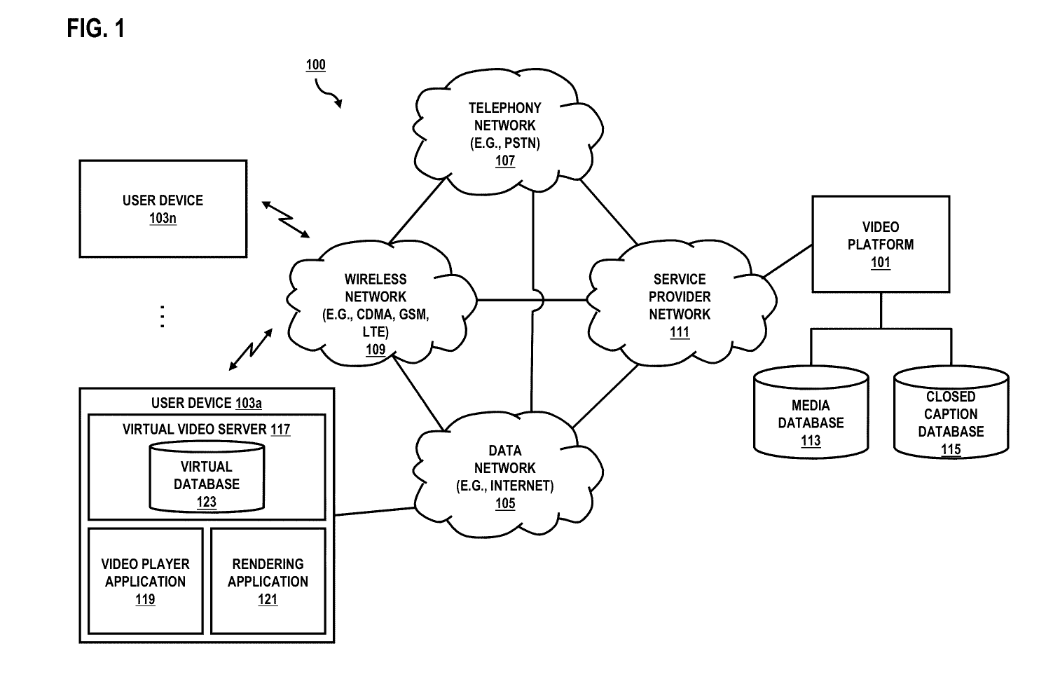

FIG. 1 is a diagram of a system capable of providing synchronized playback of media streams and corresponding closed captions, according to an exemplary embodiment. For the purpose of illustration, the system 100 employs a video platform 101 that is configured to interface with one or more user devices 103 (or user devices 103a-103n) over one or more networks (e.g., data network 105, telephony network 107, wireless network 109, etc.). According to one embodiment, services including the transmission of media streams and corresponding closed captions may be part of managed services supplied by a service provider (e.g., a wireless communication company) as a hosted or subscription-based service made available to users of the user devices 103 through a service provider network 111. As shown, the video platform 101 may be a part of or connected to the service provider network 111 (e.g., as part of an external video server). In certain embodiments, the video platform 101 may include or have access to a media database 113 and a closed caption database 115. For example, the video platform 101 may access the media database 113 to acquire one or more portions of media streams and the closed caption database 115 to acquire corresponding closed caption data for transmission to the user devices 103. As illustrated, the user devices 103 may include a virtual video server 117, a video player application 119, and a rendering application 121. In various embodiments, the virtual video server 117 interacts with the video platform 101 to receive the portions of media streams and their corresponding closed caption data. The portions, the corresponding closed caption data, and other media-related data may, for instance, be stored at a virtual database 123 for later use by the virtual video server 117 or other applications of the user device 103. As used herein, media streams may include any audio-visual content (e.g., broadcast television programs, video-on-demand (VOD) programs, pay-per-view programs, Internet Protocol television (IPTV) feeds, etc.), pre-recorded media content, data communication services content (e.g., commercials, advertisements, videos, movies, songs, images, sounds, etc.), Internet services content (streamed audio, video, or image media), and/or any other equivalent media form. While specific reference will be made thereto, it is contemplated that the system 100 may embody many forms and include multiple and/or alternative components and facilities.

It is also noted that the user devices 103 may be any type of mobile or computing terminal including a mobile handset, mobile station, mobile unit, multimedia computer, multimedia tablet, communicator, netbook, Personal Digital Assistants (PDAs), smartphone, media receiver, personal computer, workstation computer, set-top box (STB), digital video recorder (DVR), television, automobile, appliance, etc. It is also contemplated that the user devices 103 may support any type of interface for supporting the presentment or exchange of data. In addition, user devices 103 may facilitate various input means for receiving and generating information, including touch screen capability, keyboard and keypad data entry, voice-based input mechanisms, accelerometer (e.g., shaking the user device 103), and the like. Any known and future implementations of user devices 103 are applicable. It is noted that, in certain embodiments, the user devices 103 may be configured to establish peer-to-peer communication sessions with each other using a variety of technologies—i.e., near field communication (NFC), Bluetooth, infrared, etc. Also, connectivity may be provided via a wireless local area network (LAN). By way of example, a group of user devices 103 may be configured to a common LAN so that each device can be uniquely identified via any suitable network addressing scheme. For example, the LAN may utilize the dynamic host configuration protocol (DHCP) to dynamically assign “private” DHCP internet protocol (IP) addresses to each user device 103, i.e., IP addresses that are accessible to devices connected to the service provider network 111 as facilitated via a router.

As mentioned, the individual renderings of the video stream and the closed captions, for instance, by separate applications may cause the video stream and the closed captions to become out of sync with each other. For example, in the context of adaptive streaming, a video player application and a closed caption rendering application may respectively be selected to playback video chunks (or portions) of a video stream and closed caption data (e.g., associated with closed caption files) corresponding to the video chunks. Although the video chunks and the corresponding closed caption data may be delivered to, or received by, the respective applications prior to either of the individual renderings, the video player application typically must buffer the video chunks before the video chunks can be rendered. As a result, even if the video chunks and the corresponding closed caption data are delivered to the respective applications at the same time, the closed caption rendering application may start rendering the corresponding closed caption data before the video player application begins rendering the video chunks. Thus, the playback of the video chunks and the corresponding closed caption data may not be synchronized. In a further example, the video player application may even be setup to start rendering the video stream after it downloads the first few video chunks of the video stream, for instance, to reduce the risk that the playback of the video chunks and corresponding closed caption data will become unsynchronized. Nonetheless, situations such as network congestions can increase the latency, causing momentary “flickers” in the playback of the video chunks, for instance, if the video player application does not buffer enough video chunks before rendering them. Consequently, the “flickers” slow down the playback of the video chunks, which may result in the video chunks being rendered after the rendering of their respective closed caption data. That is, notwithstanding an initially synchronized playback, the playback of the video chunks and the corresponding closed caption data may still become unsynchronized.

To address this issue, the system 100 of FIG. 1 introduces the capability to effectively provide synchronized playback of media streams and corresponding closed captions, for instance, through the use of a virtual video server resident on a user device (e.g., the virtual video server 117 of the user device 103). It is noted that although various embodiments are described with respect to video streams, it is contemplated that the approach described herein may also be used for any other media streams, such as radio programming, audio streams, etc. By way of example, the video platform 101 may transmit portions of a media stream and corresponding closed caption data to the user device 103 from an external video server (e.g., of the service provider network 111). The portions of the media stream and the corresponding closed caption data may then be received by the virtual video server 117 resident on the user device 103, where the portions of the media stream and the corresponding closed caption data are buffered (e.g., using the virtual database 123). The virtual video server 117 may then deliver the portions of the media stream to the video player application 119 and the corresponding closed caption data to the rendering application 121 as to synchronize playback of the portions of the media stream and the corresponding closed caption data by the respective applications. It is noted that, in some embodiments, the video player application 119 may be independent of the rendering application 121, and the rendering application 121 may be independent of the video player application 119. As such, the video player application 119 can operate without the rendering application 121, and the rendering application 121 can operate without the video player application 119. For example, the video player application 119 may work with a different rendering application, while the rendering application 121 may work with a different video player application. The following scenarios illustrate typical situations in which the virtual video server 117 can be more effective in providing synchronized playback of media streams and corresponding closed captions.

In one scenario, a user may initiate a request (e.g., via a web portal, an electronic program guide, etc.) for media content (e.g., television show, movie, etc.) using the user device 103, which may, for instance, be submitted by the virtual video server 117 to a media service. The media service may then begin transmitting a media stream associated with the media content in portions along with closed caption data corresponding to the portions of the media stream to the virtual video server 117. As such, the transmitted portions and corresponding closed caption data may be buffered at the virtual video server 117 (e.g., using the virtual database 123) and thereafter selectively delivered to the video player application 119 and the rendering application 121. By way of example, the virtual video server 117 may only deliver a few of the available portions (e.g., stored at the virtual database 123 of the user device 103, a memory of the user device 103, etc.) at a time to the video player application 119 and the corresponding closed caption data of the few selected portions to the rendering application 121. In this way, the rendering of the few selected portions of the media stream may be begin without the delay associated with having to buffer a large set of portions prior to rendering such portions since the number of portions of the media stream that the video player application 119 has to buffer at a time is decreased. Consequently, the video player application 119 and the rendering application 121 can begin rendering their respective content at the same time. In addition, because the portions and the corresponding closed caption data are locally stored and delivered by the virtual video server 117 resident on the user device 103, synchronization issues associated with network congestion, latency relating to such congestion, etc., may be avoided.

In a further scenario, the virtual video server 117 may also providing timing information with respect to the few selected portions to the video player application 119 and the rendering application 121 along with the few selected portions and the corresponding closed caption data. By way of example, the virtual video server 117 may estimate the amount of time that the video player application 119 will take to buffer the few selected portions. As such, the timing information may include a suggested time for the video player application 119 to begin rendering the few selected portions and the rendering application 121 to begin rendering the corresponding closed caption data based on the estimation. Since numerous factors, such as network congestion, network bandwidth, and other network-related factors, can be eliminated from the time-to-buffer estimation for the video player application 119, the suggested start time based on the calculated estimate is more likely to consistently produce synchronized playback of the portions of the media stream and the corresponding caption data by the respective applications.

In certain embodiments, the metadata associated with the media stream may be modified, for instance, by the virtual video server 117 to indicate to the video player application 119, the rendering application 121, or a combination thereof that a subset of the one or more portions of the media stream is not available. In one use case, the transmission of the one or more portions and the corresponding closed caption data from the external video server to the virtual video server 117 resident at the user device 103 may include metadata indicating that the one or more portions and the corresponding closed caption data have been transmitted to the user device 103. As mentioned, it may be advantageous to limit the number of portions that the video player application 119 buffers at a time (e.g., to reduce delay associated with having to buffer a large data set). As such, the virtual video player 117 may modify the metadata to hide the fact that the full set of the one or more portions and the corresponding closed caption data are locally stored at the user device 103. That is, the metadata can be modified to indicate at least to the video player application 119 that only the few selected portions (e.g., selected by the virtual video server 117 from the full set of the one or more portions received) are available for the video player application 119. Accordingly, the video player application 119 may only attempt to buffer the few selected portions and begin rendering the few selected portions before looking again to see if any more portions of the media stream are available to proceed with further streaming (e.g., from the virtual video server 117).

In various embodiments, a uniform resource locator (URL) for the one or more portions of the media stream, the corresponding closed caption data, or a combination thereof at the user device 103 may be generated, for instance, by the virtual video server 117. Since streaming media player applications commonly utilize URLs to stream or download media content, the generation of the local URL (e.g., at the user device 103) enables the virtual video server 117 to work with typical streaming media player applications with little, or no, modifications to the streaming media player applications. In one scenario, the one or more portions may actually be stored at a physical address in a memory of the user device 103. As such, the generated URL may be an index or a pointer to the physical address in the memory that will support the streaming operations of the video player application 119. Additionally, or alternatively, the virtual video server 117 may also provide separate open pipes (e.g., Hypertext Transfer Protocol (HTTP) open pipes) for the delivery of the one or more portions and the corresponding closed caption data. Thus, the one or more portions and the corresponding closed caption data may simultaneously be delivered to the respective applications to enable immediate and synchronized playback of the one or more portions and the corresponding closed caption data.

In other embodiments, the virtual video server 117 may be represented as the video player application 119, the rendering application 121, or a combination thereof to the external video server, and the virtual video server may be represented as the external video server to the video player application 119, the rendering application 121, or a combination thereof. By way of an example, the video player application 119 may be the default media player for the user device 103. As such, if a user of the user device 103 initiates a request (e.g., via a web portal, a electronic program guide, etc.) for a particular media content, the media stream associated with the media content will be rendered by the video player application 119. If, for instance, the video player application 119 can only accept certain streaming formats (e.g., based on capability), an external video server may determine to transmit media streams with acceptable formats to the user device 103. Thus, the virtual video server 117 may be represented as the video player application 119 (e.g., in light of the default status of the video player application 119) so that the external video server will know to transmit media stream with formats acceptable for the video player application 119.

In additional embodiments, an initiation of a user command relating to the playback of the one or more portions of the media stream may be determined, for instance, by the rendering application 121. In one use case, the rendering application 121 may listen to the set of user commands relating to the rendering of the media stream, such as play, pause, stop, and trick mode keys, once the rendering of the media stream has begun. As such, the playback of the corresponding closed caption data may be based on the initiation of the user command since the rendering application 121 can manipulate the rendering of the corresponding closed caption data according to the detected user commands (e.g., that are sent to the video player application 119).

In further embodiments, a selection of a language by a user of the user device from a plurality of languages for the media stream may be determined, for instance, by the rendering application 121. Thus, the playback of the corresponding closed caption data may be based on the language selection. It is noted that the user may select the desired language before the rendering of the media stream, when the rendering of the media stream begins, or after the rendering of the media stream has begun. Moreover, because the corresponding closed caption data is not actually part of the media stream (or part of the respective portions of the media stream), the rendering application 121 has the potential to support unlimited closed caption language options. Specifically, the separation of the media stream and the corresponding closed caption data enables the rendering application 121 to efficiently switch languages of the corresponding closed caption data, for instance, by controlling the set of closed caption files that the corresponding closed caption data are rendered from based on the user's selection.

In some embodiments, the video platform 101, the user devices 103, and other elements of the system 100 may be configured to communicate via the service provider network 111. According to certain embodiments, one or more networks, such as the data network 105, the telephony network 107, and/or the wireless network 109, may interact with the service provider network 111. The networks 105-109 may be any suitable wireline and/or wireless network, and be managed by one or more service providers. For example, the data network 105 may be any local area network (LAN), metropolitan area network (MAN), wide area network (WAN), the Internet, or any other suitable packet-switched network, such as a commercially owned, proprietary packet-switched network, such as a proprietary cable or fiber-optic network. The telephony network 107 may include a circuit-switched network, such as the public switched telephone network (PSTN), an integrated services digital network (ISDN), a private branch exchange (PBX), or other like network. Meanwhile, the wireless network 109 may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like.

Although depicted as separate entities, the networks 105-109 may be completely or partially contained within one another, or may embody one or more of the aforementioned infrastructures. For instance, the service provider network 111 may embody circuit-switched and/or packet-switched networks that include facilities to provide for transport of circuit-switched and/or packet-based communications. It is further contemplated that the networks 105-109 may include components and facilities to provide for signaling and/or bearer communications between the various components or facilities of the system 100. In this manner, the networks 105-109 may embody or include portions of a signaling system 7 (SS7) network, Internet protocol multimedia subsystem (IMS), or other suitable infrastructure to support control and signaling functions.

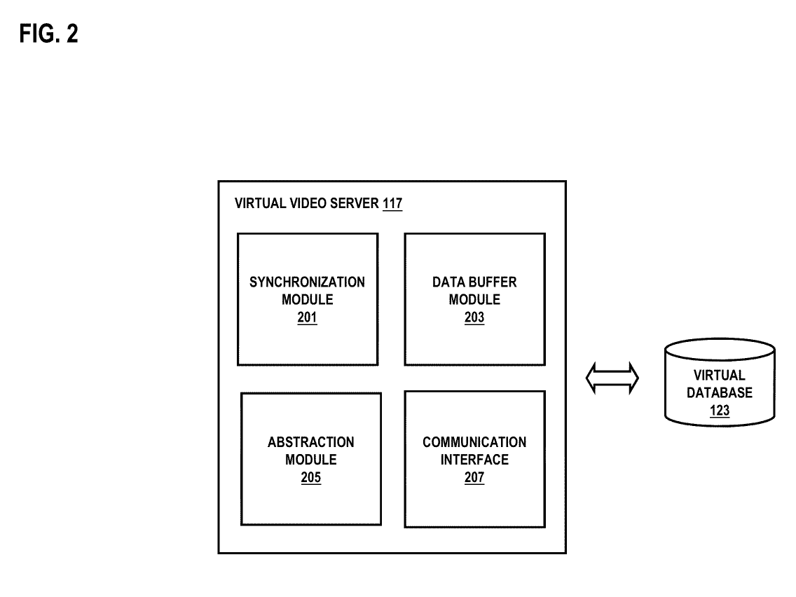

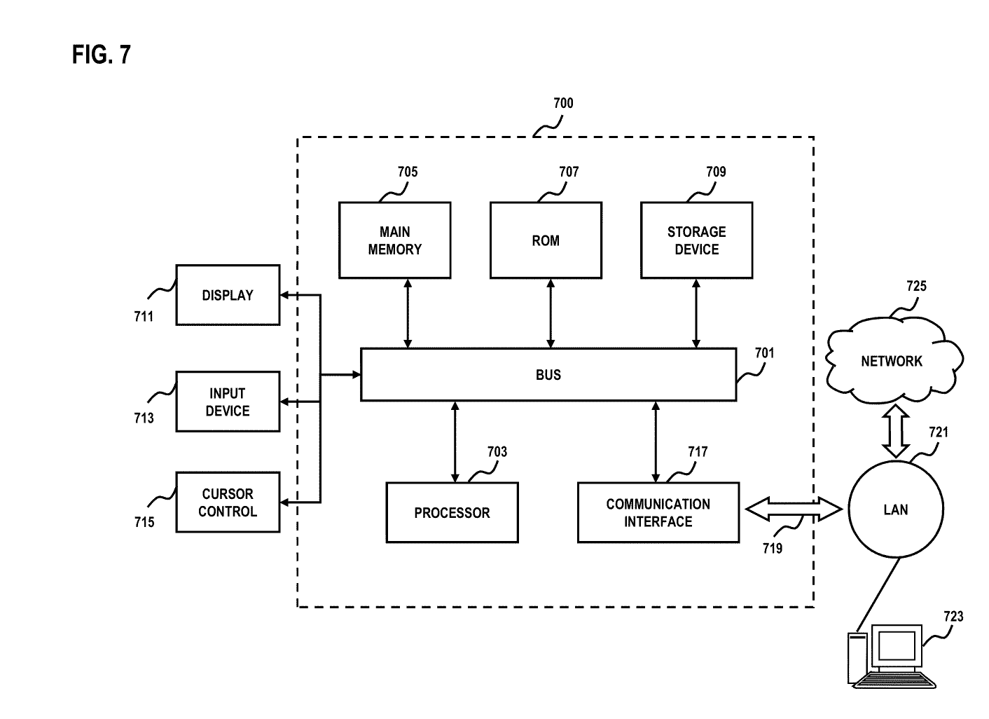

FIG. 2 is a diagram of the components of a virtual video server, according to an exemplary embodiment. The virtual video server 117 may comprise computing hardware (such as described with respect to FIG. 7), as well as include one or more components configured to execute the processes of the system 100 described herein. It is contemplated that the functions of these components may be combined in one or more components or performed by other components of equivalent functionality. In one implementation, the virtual video server 117 includes a synchronization module 201, a data buffer module 203, an abstraction module 205, and a communication interface 207.

By way of example, the synchronization module 201 may receive (e.g., via the communication interface 207) portions of a media stream and corresponding closed caption data from an external video server. In one use case, such as in the context of over-the-top (OTT) streaming, the media stream may be separated into different time-based chunks, for instance, by the external video server. Each chunk (or portion) of the media stream may be associated with a particular closed caption file (e.g., .srt files, .dsfx files, etc.) that may be determined based on metadata associated with the media stream (or the individual portions of the media stream).

Upon receipt of the portions of the media stream and the corresponding closed caption data, the data buffer module 203 may then buffer the portions of the media stream and the corresponding closed caption data. As mentioned, the respective content may be buffered using, for instance, the virtual database 123 associated with the virtual video server 117. The synchronization module 201 may thereafter deliver the portions of the media stream to the video player application 119 and the corresponding closed caption data to the rendering application 121 in such a way as to synchronize playback of the portions of the media stream and the corresponding closed caption data. As noted, in some embodiments, the video player application 119 may be independent of the rendering application 121, and the rendering application 121 may be independent of the video player application 119. As discussed, in one scenario, the portions of the media stream and the corresponding closed caption data may be selectively delivered such that only a few of the received portions and their corresponding closed caption data are delivered at a time to the respective applications. It is noted that such selection may be performed, for instance, by the abstraction module 205, to hide the fact that non-selected portions have been received by the user device 103. As such, the video player application 119 may only have to buffer the few selected portions, rather than all of the received portions, which may enable faster rendering of the portions of the media stream.

Additionally, or alternatively, the abstraction module 205 may modified the metadata associated with the media stream (or the respective portions of the media stream) to indicate to the video player application 119 and/or the rendering application 121 that a subset of the received portions of the media stream is not available. Similarly, such an approach can be used to hide the fact that the full set of the received portions are locally stored at the user device 103. Specifically, for instance, the video player application 119 may only be aware that a few selected portions (e.g., selected by the virtual video server 117 from the full set of the one or more portions received) are available based on the modified metadata. As a result, the video player application 119 may only attempt to buffer the few selected portions and begin rendering the few selected portions before looking again to see if any more portions of the media stream are available to proceed with further streaming (e.g., from the virtual video server 117).

As indicated, the communication interface 207 may be utilized to communicate with other components of the virtual video server 117. In addition, the communication interface 207 may be used to communicate with other components of the user device 103 and the system 100. The communication interface 207 may include multiple means of communication. For example, the communication interface 207 may be able to communicate over short message service (SMS), multimedia messaging service (MMS), internet protocol (IP), instant messaging, voice sessions (e.g., via a phone network), email, or other types of communication. By way of example, such methods may be used to receive the portions of the media stream and the corresponding closed caption data from the video platform 101.

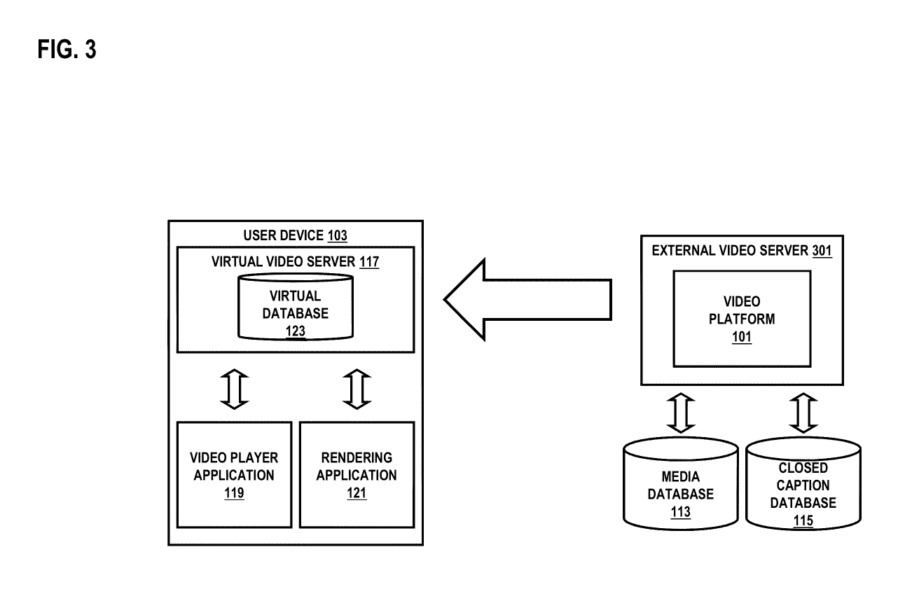

FIG. 3 is a diagram of interactions between components of an external video server and a user device, according to an exemplary embodiment. For illustrative purposes, the diagram is described with reference to the system 100 of FIG. 1. As indicated, the external video server 301 is transmitting the portions of the media stream and the corresponding closed caption data to the virtual video server 117 resident on the user device 103. Additionally, or alternatively, metadata associated with the portions of the media stream may be transmitted as part of the portions of the media stream or as separate files. The portions of the media stream, the metadata associated with the portions of the media stream, and the corresponding closed caption data may, for instance, be obtained by the video platform 101 of the external video server 301 from the media database 113 and the closed caption database 115.

As mentioned, upon receipt of the portions of the media stream and the corresponding closed caption data, the virtual video server 117 may buffer the received portions and the corresponding closed caption data using the virtual database 123. Moreover, the virtual video server 117 may provide separate open pipes (e.g., HTTP open pipes) to enable parallel transmission of the portions of the media stream and the corresponding closed caption data. Using the open pipes, the virtual video server 117 may simultaneously deliver the portions of the media stream and the corresponding closed caption data to the respective applications in such a way as to synchronize the playback of the portions of the media stream and the corresponding closed caption data. It is noted that, in some embodiments, the virtual video server 117 may be represented as the video player application 119 or the rendering application to the external server, and represented as the external video server to the video player application 119 or the rendering application. In this way, as indicated, the needs and the capabilities (e.g., acceptable formats) of the video player application 119 or the rendering application 121 may be represented to the external video server, and the requirements and capabilities of the external video server may be represented to the video player application 119 or the rendering application 121.

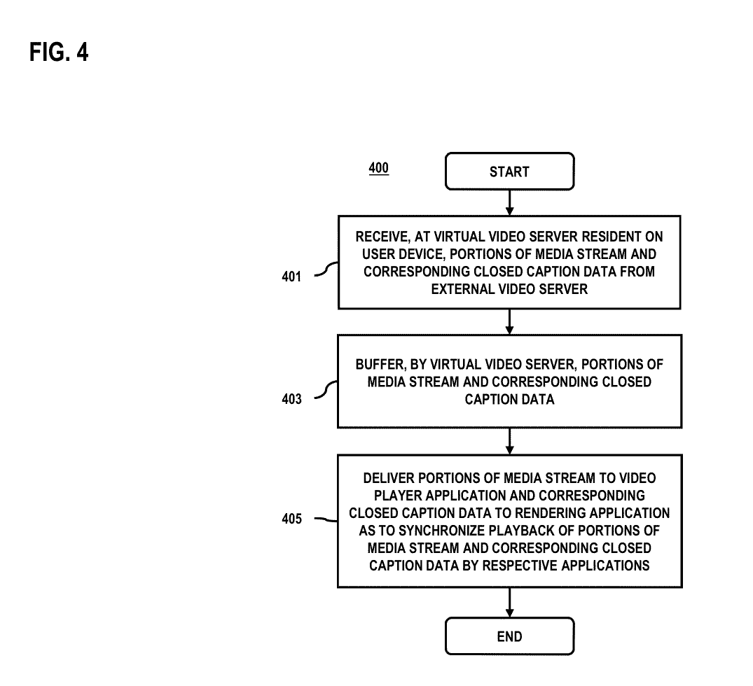

FIG. 4 is a flowchart of a process for providing synchronized playback of media streams and corresponding closed captions, according to an exemplary embodiment. For the purpose of illustration, process 400 is described with respect to FIG. 1. It is noted that the steps of the process 400 may be performed in any suitable order, as well as combined or separated in any suitable manner. In step 401, the virtual video server 117 resident on the user device 103 may receive one or more portions of a media stream and corresponding closed caption data from an external video server. Upon receipt of the one or more portions of the media stream and the corresponding closed caption data, the virtual video server 117 may then, in step 403, buffer the one or more portions of the media stream and the corresponding closed caption data.

By way of example, the virtual database 123 may support the buffering of the one or more portions of the media stream and the corresponding closed caption data. In one scenario, the virtual database 123 may logically represent a region of physical memory storage at the user device 103 that is used to temporarily hold the one or more portions of the media stream and the corresponding closed caption data along with other media-related data (e.g., metadata associated with the media stream). In this way, the one or more portions of the media stream and the corresponding closed caption data are already available at the user device 103 to be transmitted to respective applications (e.g., the video player application 119, the rendering application 121, etc.), avoiding network-related issues that typically affect synchronized playback of media streams and corresponding closed caption data. Moreover, the local availability of the one or more portions of the media stream and the corresponding closed caption data at the user device 103 may enable nearly immediate transfers to, and quicker buffering by, the respective applications (e.g., as compared to typical transfers and buffering from the external video server).

In step 405, the virtual video server 117 may deliver the one or more portions of the media stream to the video player application 119 and the corresponding closed caption data to the rendering application 121 as to synchronize playback of the one or more portions of the media stream and the corresponding closed caption data by the respective applications, wherein the video player application 119 and the rendering application 121 are resident on the user device 103. As discussed, in one use case, selective delivery of the one or more portions of the media stream and the corresponding closed caption data may be implemented such that only a few selected portions of the one or more portions of the media stream along with its corresponding closed caption data are delivered at a time to the respective applications. The number of portions for each delivery may, for instance, be predetermined based on the total size of the media stream, the size of the individual portions, etc. Additionally, or alternatively, the video player application 119 may be independent of the rendering application 121, and the rendering application 121 may be independent of the video player application 119.

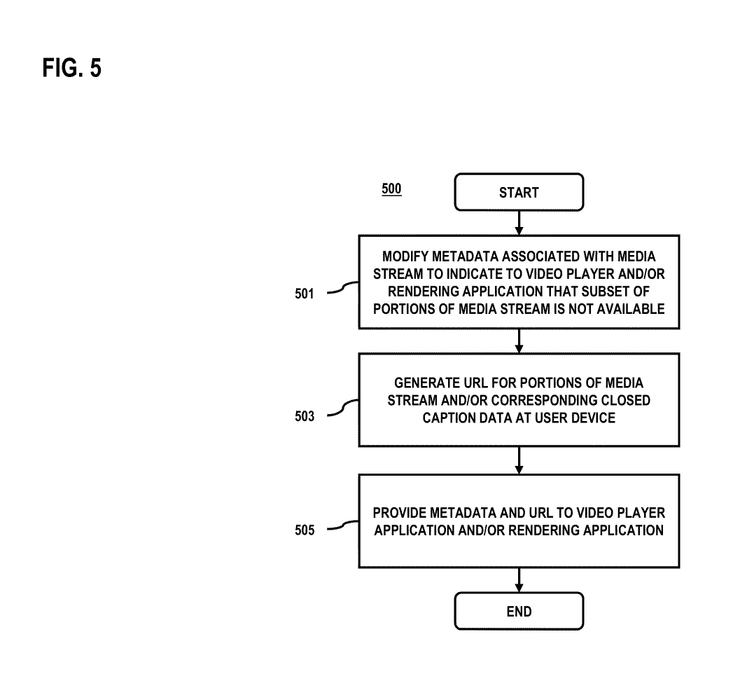

FIG. 5 is a flowchart of a process for addressing synchronization issues with respect to playback of media streams and corresponding closed captions, according to an exemplary embodiment. For the purpose of illustration, process 500 is described with respect to FIG. 1. It is noted that the steps of the process 500 may be performed in any suitable order, as well as combined or separated in any suitable manner. In step 501, the virtual video server 117 may modify metadata associated with the media stream to indicate to the video player application 119, the rendering application 121, or a combination thereof that a subset of the one or more portions of the media stream is not available. Additionally, or alternatively, the modified metadata may indicate to the video player application 119, the rendering application 121, or a combination thereof that only another subset of the one or more portions of the media stream is available. Such approaches may, for instance, be used to hide the fact that the full set of the received one or more portions are locally stored at the user device 103. Consequently, for instance, the video player application 119 may only be aware that the few selected portions (e.g., selected by the virtual video server 117 from the full set of the one or more portions received) are available based on the modified metadata. In this way, unnecessarily long buffering of the one or more portions by the video player application 119 may be prevented, which enables the video player application 119 to avoid delays in the playback of the one or more portions of the media stream.

In step 503, the virtual video server 117 may generate a URL for the one or more portions of the media stream, the corresponding closed caption data, or a combination thereof at the user device 103. As discussed, streaming media player applications commonly utilize URLs to stream or download media content. Similarly, typical closed caption rendering applications may also utilize URLs to obtain closed caption files. Thus, the generation of the URL by the virtual video server 117 may enable the virtual video server 117 to support such applications that may require the use of URL. Therefore, these common applications may work with the virtual video server 117 with little, or no, modifications to the applications. Accordingly, the virtual video server 117 may then, in step 505, provide the metadata and the URL to the video player application 119, the rendering application 121, or a combination thereof. As such, the playback of the one or more portions of the media stream and the corresponding closed caption data may be based on the metadata and the generated URL.

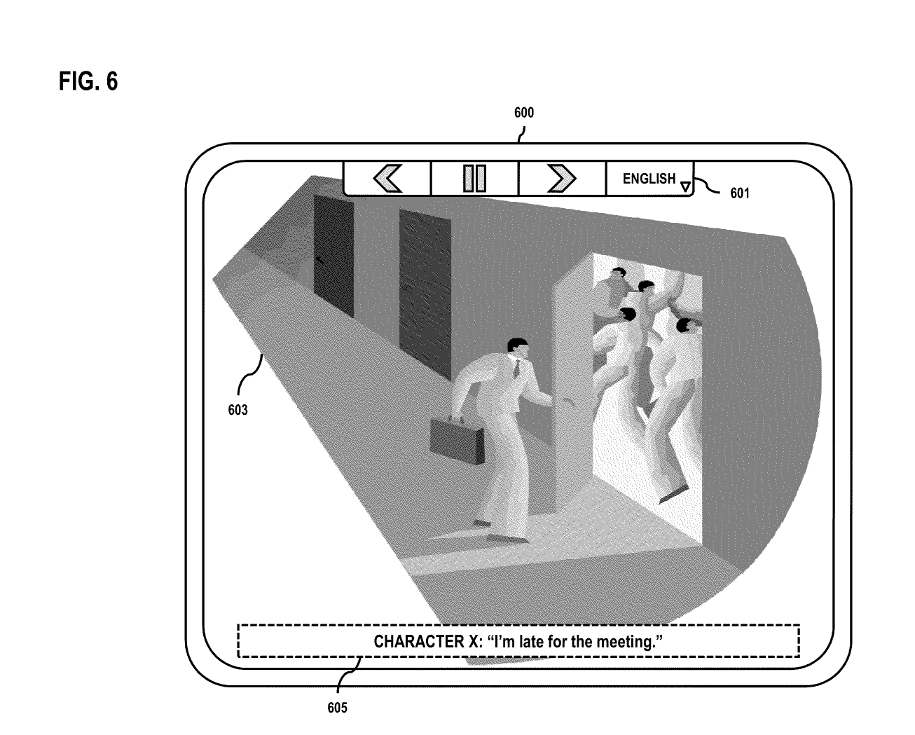

FIG. 6 is a diagram of a user interface for illustrating synchronization of a media stream and corresponding closed captions, according to an exemplary embodiment. For illustrative purposes, the diagram is described with reference to the system 100 of FIG. 1. As shown, the diagram features the user interface 600 with options 601, a snapshot 603 of a portion of a media stream, and the corresponding closed caption 605. In this scenario, the particular portion of the media and its corresponding closed caption data are synchronously being rendered on the user interface 600. As explained, upon receipt of one or more portion of the media stream and the corresponding closed caption data from an external video server, the virtual video server 117 buffers the one or more portions of the media stream and the corresponding closed caption data, for instance, at the user device 103 using the virtual database 123. The one or more portions of the media stream and the corresponding closed caption data are then respectively delivered to the video player application 119 and the rendering application 121 as to synchronize the playback of the video player application 119 and the rendering application 121. As discussed, this may include selectively delivering the one or more portions of the media stream (e.g., a few selected portions at a time) and the corresponding closed caption data, or modifying metadata associated with the media stream (or the individual portions of the media stream) to indicate to the video player application 119 and/or the rendering application 121 that only the few selected portions are available at the current time.

As illustrated, the corresponding closed caption 605 notifies the user in the English language that Character X is stating that he is late for the meeting. If, however, the user cannot understand the English language, or wants to see closed captions in another language, the user can select the language dropdown menu (e.g., which currently indicates “English” as the language for the closed caption) of the options 601 to select another language. If another language is selected, the language selection will be detected by the rendering application 121, which will then seamlessly render the corresponding closed caption data in the new selected language. As noted, the rendering application 121 may effectively and efficiently perform the immediate rendering of the new selected language, for instance, by switching to the set of closed caption files associated with the new selected language. In addition, the user may initiate the user commands of the options 601 to rewind, to pause, or to fast forward the playback of the one or more portions of the media stream. As mentioned, the rendering application 121 may detect such initiations of the user commands as the user commands are transmitted to the video player application 119. Based on the detection, the rendering application 121 may manipulate the rendering of the corresponding closed caption data according to the transmitted user commands. In this way, the rendering of the corresponding closed caption data remains precise and synchronized with the rendering of the one or more portions of the media stream.

The processes described herein for providing synchronized playback of media streams and corresponding closed captions may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 7 is a diagram of a computer system that can be used to implement various exemplary embodiments. The computer system 700 includes a bus 701 or other communication mechanism for communicating information and one or more processors (of which one is shown) 703 coupled to the bus 701 for processing information. The computer system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk, flash storage, or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. Additional output mechanisms may include haptics, audio, video, etc. An input device 713, such as a keyboard including alphanumeric and other keys, is coupled to the bus 701 for communicating information and command selections to the processor 703. Another type of user input device is a cursor control 715, such as a mouse, a trackball, touch screen, or cursor direction keys, for communicating direction information and command selections to the processor 703 and for adjusting cursor movement on the display 711.

According to an embodiment of the invention, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. Thus, embodiments of the invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an embodiment of the invention through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

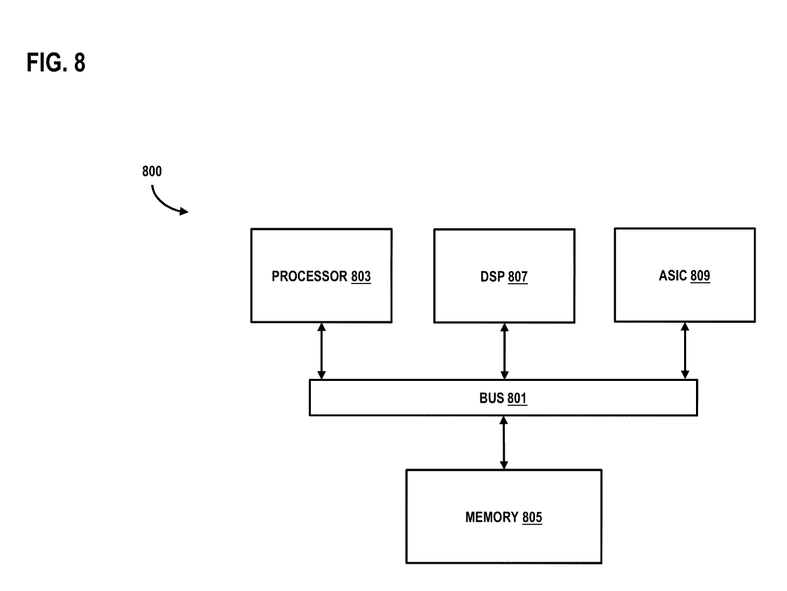

FIG. 8 illustrates a chip set or chip 800 upon which an embodiment of the invention may be implemented. Chip set 800 is programmed to enable synchronized playback of media streams and corresponding closed captions as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of enabling synchronized playback of media streams and corresponding closed captions.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to enable synchronized playback of media streams and corresponding closed captions. The memory 805 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving, at a virtual video server resident on a user device, one or more portions of a media stream and corresponding closed caption data from an external video server;
buffering, by the virtual video server, the one or more portions of the media stream and the corresponding closed caption data; and
delivering the one or more portions of the media stream to a video player application and the corresponding closed caption data to a rendering application as to synchronize playback of the one or more portions of the media stream and the corresponding closed caption data by the respective applications, wherein the video player application and the rendering application are resident on the user device.

2. A method according to claim 1, wherein the video player application is independent of the rendering application.

3. A method according to claim 1, further comprising:
modifying metadata associated with the media stream to indicate to the video player application, the rendering application, or a combination thereof that a subset of the one or more portions of the media stream is not available.

4. A method according to claim 1, further comprising:
generating a uniform resource locator (URL) for the one or more portions of the media stream, the corresponding closed caption data, or a combination thereof at the user device,
wherein the playback of the one or more portions of the media stream and the corresponding closed caption data are based on the generated URL.

5. A method according to claim 1, further comprising:
representing the virtual video server as the video player application, the rendering application, or a combination thereof to the external video server; and
representing the virtual video server as the external video server to the video player application, the rendering application, or a combination thereof.

6. A method according to claim 1, further comprising:
determining an initiation of a user command relating to the playback of the one or more portions of the media stream,
wherein the playback of the corresponding closed caption data is based on the initiation of the user command.

7. A method according to claim 1, further comprising:
determining a language selected by a user of the user device from a plurality of languages for the media stream,
wherein the playback of the corresponding closed caption data is based on the language selection.

8. An apparatus comprising:
at least one processor; and
at least one memory including computer program code for one or more programs,
the at least one memory and the computer program code configured to, with the at least one processor, cause the apparatus to perform at least the following,
receive, at a virtual video server resident on a user device, one or more portions of a media stream and corresponding closed caption data from an external video server;
buffer, by the virtual video server, the one or more portions of the media stream and the corresponding closed caption data; and
deliver the one or more portions of the media stream to a video player application and the corresponding closed caption data to a rendering application as to synchronize playback of the one or more portions of the media stream and the corresponding closed caption data by the respective applications, wherein the video player application and the rendering application are resident on the user device.

9. An apparatus according to claim 8, wherein the video player application is independent of the rendering application.

10. An apparatus according to claim 8, wherein the apparatus is further caused to:
modify metadata associated with the media stream to indicate to the video player application, the rendering application, or a combination thereof that a subset of the one or more portions of the media stream is not available.

11. An apparatus according to claim 8, wherein the apparatus is further caused to:
generate a uniform resource locator (URL) for the one or more portions of the media stream, the corresponding closed caption data, or a combination thereof at the user device,
wherein the playback of the one or more portions of the media stream and the corresponding closed caption data are based on the generated URL.

12. An apparatus according to claim 8, wherein the apparatus is further caused to:
represent the virtual video server as the video player application, the rendering application, or a combination thereof to the external video server; and
represent the virtual video server as the external video server to the video player application, the rendering application, or a combination thereof.

13. An apparatus according to claim 8, wherein the apparatus is further caused to:
determine an initiation of a user command relating to the playback of the one or more portions of the media stream,
wherein the playback of the corresponding closed caption data is based on the initiation of the user command.

14. An apparatus according to claim 8, wherein the apparatus is further caused to:
determine a language selected by a user of the user device from a plurality of languages for the media stream,
wherein the playback of the corresponding closed caption data is based on the language selection.

15. A user device comprising:
one or more processors configured to execute a virtual video server video player application, and a rendering application,
wherein the virtual video server is configured to:
receive one or more portions of a media stream and corresponding closed caption data from an external video server,
buffer the one or more portions of the media stream and the corresponding closed caption data, and
deliver the one or more portions of the media stream to the video player application and the corresponding closed caption data to the rendering application as to synchronize playback of the one or more portions of the media stream and the corresponding closed caption data by the respective applications.

16. A system according to claim 15, wherein the video player application is independent of the rendering application.

17. A system according to claim 15, wherein the virtual video server is further configured to:
modify metadata associated with the media stream to indicate to the video player application, the rendering application, or a combination thereof that a subset of the one or more portions of the media stream is not available.

18. A system according to claim 15, wherein the virtual video server further configured to:
generate a uniform resource locator (URL) for the one or more portions of the media stream, the corresponding closed caption data, or a combination thereof at the user device,
wherein the playback of the one or more portions of the media stream and the corresponding closed caption data are based on the generated URL.

19. A system according to claim 15, wherein the virtual video server is represented as the video player application, the rendering application, or a combination thereof to the external video server, and wherein the virtual video server is represented as the external video server to the video player application, the rendering application, or a combination thereof.

20. A system according to claim 15, wherein the rendering application is further configured to:
determine an initiation of a user command relating to the playback of the one or more portions of the media stream; and
determine a language selected by a user of the user device from a plurality of languages for the media stream,
wherein the playback of the corresponding closed caption data is based on the initiation of the user command and the language selection.
